(19) United States
(12) Patent Application Publication
(10) Pub. No.: US 2016/0339851 A1
(43) Pub. Date: Nov. 24, 2016

(54) INFLATABLE CARRIER FOR USE ON VEHICLES

(71) Applicant: Split Oak, Inc., Dallas, TX (US)

(72) Inventor: Tyler Samuel Nelson, Dallas, TX (US)

(21) Appl. No.: 14/716,831

(22) Filed: May 19, 2015

(51) Int. Cl. B60R 9/10; B60R 9/06

(52) U.S. Cl. CPC B60R 9/10; B60R 9/06

(57) ABSTRACT

Particular embodiments described herein provide for an inflatable carrier for use on a vehicle. The inflatable carrier can include securing straps to secure the air filled carrier to the vehicle and transportable item securing straps to secure a transportable item to the air filled carrier. The air filled carrier can be inflatable and deflatable (i.e., the air filed carrier can be inflated and deflated). Also, the air filled carrier can include a tightening mechanism to tighten the securing straps and secure the air filled carrier to the vehicle and a transportable item securing mechanism that can be used to tighten the transportable item securing straps to secure the transportable item to the air filled carrier.

### FIELD OF THE DISCLOSURE

Embodiments described herein generally relate to the field of carriers, and more particularly, to carriers for use on vehicles.

### BACKGROUND

Bicycling or cycling is an efficient and effective mode of transportation and can provide numerous benefits compared to motor vehicles, including a means of exercise, an alternative to the use of fossil fuels, reducing air and noise pollution, as well as reducing traffic congestion. However, there are certain instances when the use of a motor vehicle is necessary to transport the bicycle from one location to another location. Hence, there is a need for a system and method for transporting a bicycle from one location to another location using a motor vehicle.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified orthographic view illustrating an embodiment of an inflatable carrier for use on vehicles, in accordance with one embodiment of the present disclosure;

FIG. 1B is a simplified side view illustrating an embodiment of an inflatable carrier for use on vehicles, in accordance with one embodiment of the present disclosure;

FIG. 2 is a simplified orthographic view illustrating an embodiment of an inflatable carrier for use on vehicles, in accordance with one embodiment of the present disclosure;

FIG. 3 is a simplified orthographic view illustrating an embodiment of an inflatable carrier for use on vehicles, in accordance with one embodiment of the present disclosure;

FIG. 4 is a simplified orthographic view illustrating an embodiment of an inflatable carrier for use on vehicles, in accordance with one embodiment of the present disclosure;

FIG. 5 is a simplified orthographic view illustrating an embodiment of an inflatable carrier for use on vehicles, in accordance with one embodiment of the present disclosure;

FIG. 6 is a simplified orthographic view illustrating an embodiment of an inflatable carrier for use on vehicles, in accordance with one embodiment of the present disclosure;

FIG. 7A is a simplified side view illustrating an embodiment of an inflatable carrier for use on vehicles, in accordance with one embodiment of the present disclosure;

FIG. 7B is a simplified orthographic view illustrating an embodiment of an inflatable carrier housing, in accordance with one embodiment of the present disclosure;

FIG. 7C is a simplified side view illustrating an embodiment of a portion of an inflatable carrier housing, in accordance with one embodiment of the present disclosure;

FIG. 7D is a simplified side view illustrating an embodiment of a portion of an inflatable carrier housing, in accordance with one embodiment of the present disclosure;

FIG. 8A is a simplified orthographic view illustrating an embodiment of an inflatable carrier for use on vehicles, in accordance with one embodiment of the present disclosure;

FIG. 8B is a simplified plan view illustrating an embodiment of an inflatable carrier for use on vehicles, in accordance with one embodiment of the present disclosure;

FIG. 9A is a simplified plan view illustrating an embodiment of an inflatable carrier for use on vehicles, in accordance with one embodiment of the present disclosure;

FIG. 9B is a simplified orthographic view illustrating an embodiment of an inflatable carrier for use on vehicles, in accordance with one embodiment of the present disclosure;

FIG. 9C is a simplified orthographic view illustrating an embodiment of an inflatable carrier for use on vehicles, in accordance with one embodiment of the present disclosure;

FIG. 10 is a simplified orthographic view illustrating an embodiment of an inflatable carrier for use on vehicles, in accordance with one embodiment of the present disclosure;

FIG. 11 is a simplified plan view illustrating an embodiment of an inflatable carrier for use on vehicles, in accordance with one embodiment of the present disclosure;

FIG. 12 is a simplified plan view illustrating an embodiment of an inflatable carrier for use on vehicles, in accordance with one embodiment of the present disclosure; and

FIG. 13 is a simplified flowchart illustrating potential operations that may be associated with the inflatable carrier in accordance with an embodiment.

The FIGURES of the drawings are not necessarily drawn to scale, as their dimensions can be varied considerably without departing from the scope of the present disclosure.

### DETAILED DESCRIPTION OF THE EMBODIMENTS

### Overview

In an example, there is disclosed a system, an apparatus, and a method for an inflatable carrier for use on vehicles. In one example, an inflatable carrier can include securing straps to secure an air filled carrier to a vehicle and transportable item securing straps to secure a transportable item to the air filled carrier. The air filled carrier can be inflatable and deflatable (i.e., the air filed carrier can be inflated and deflated). Also, the air filled carrier can include a tightening mechanism to tighten the securing straps and secure the air filled carrier to the vehicle and a transportable item securing mechanism can be used to tighten the transportable item securing straps to secure the transportable item to the air filled carrier.

### EXAMPLE EMBODIMENTS

The following detailed description sets forth example embodiments of apparatuses, methods, and systems relating to low-profile hinge configurations for an electronic device. Features such as structure(s), function(s), and/or characteristic(s), for example, are described with reference to one embodiment as a matter of convenience; various embodiments may be implemented with any suitable one or more of the described features.

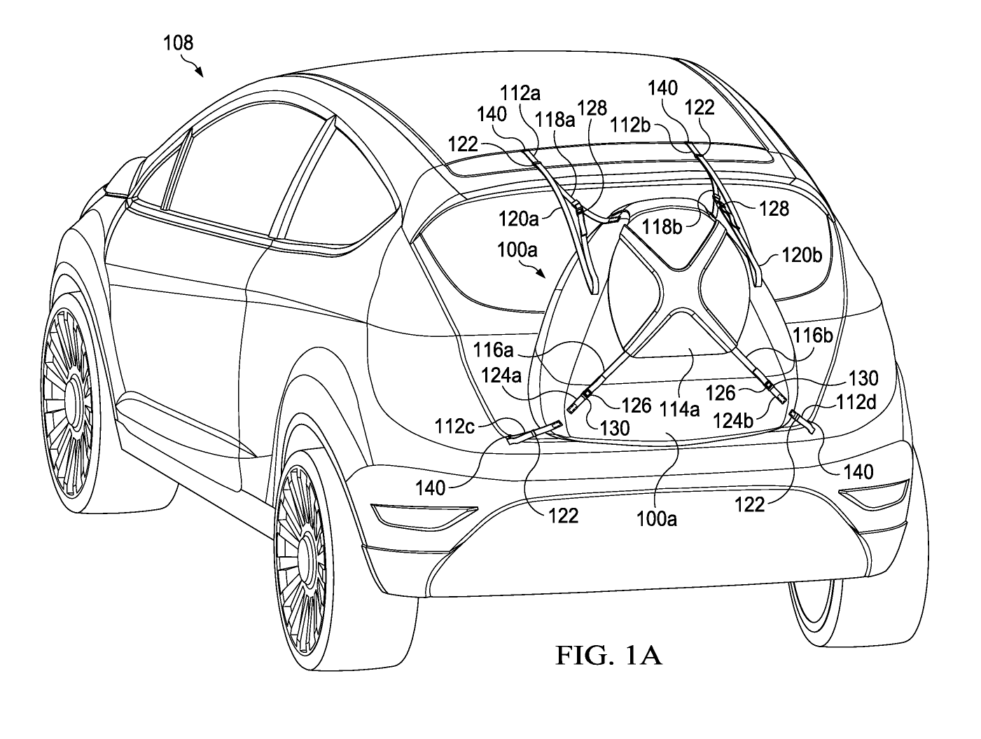

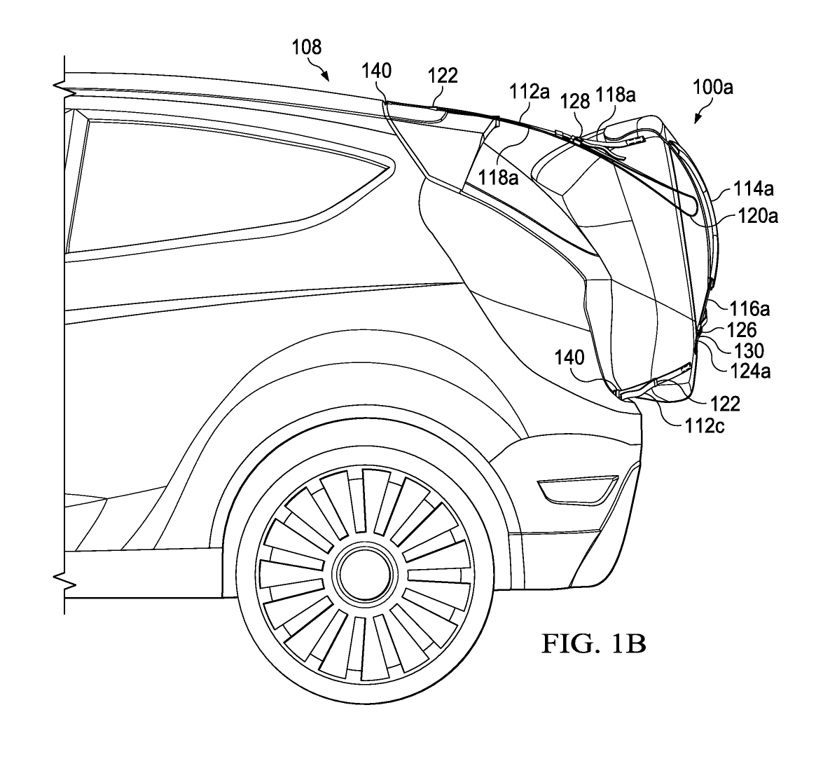

Turning to FIG. 1A, FIG. 1A is a simplified orthographic view illustrating an embodiment of an inflatable carrier 100a in accordance with one embodiment of the present disclosure. Inflatable carrier 100a may be attached to a vehicle 108. Vehicle 108 may be a car, street utility vehicle (SUV), hybrid vehicle, cross-over vehicle, minivan, sports car, or some other similar type of vehicle.

In one or more embodiments, inflatable carrier 100a can include vehicle securing straps 112a-112d. One end of each vehicle securing straps 112a-112d can be secured to vehicle 108 using vehicle securing hooks 140 while the other end may be secured or attached to inflatable carrier 100a. In an example, after vehicle securing hooks 140 are attached to vehicle 108, tightening mechanism 122 can be used to tighten vehicle securing straps 112a-112d and secure inflatable carrier 100a to vehicle 108. Tightening mechanism 122 may be located on each vehicle securing strap 112a-112d and may be a cam clasp, ratchet, buckle, or some other type of mechanism or device that will allow vehicle securing straps 112a-112d to be tightened and secure inflatable carrier 100a to vehicle 108.

Vehicle securing straps 112a and 112b can each include an inflatable carrier securing strap 118a and 118b and a transportable item securing storage strap 120a and 120b respectively. In an example, when a transportable item is placed in each transportable item securing storage strap 120a and 120b or each transportable item securing storage strap 120a and 120b is wrapped around the transportable item, transportable item securing mechanism 128 may be used to secure the transportable item to inflatable carrier 100a. Transportable item securing mechanism 128 may be located on each transportable item securing storage strap 120a and 120b and may be a cam clasp, ratchet, buckle, or some other type of mechanism or device that will allow transportable item securing straps 120a and 120b to be tightened and secure the transportable item to inflatable carrier 100a.

Inflatable carrier 100a can also include transportable item flap 114a. Transportable item flap 114a can include flap straps 116a and 116b. Each flap strap 116a and 116b can include a first flap strap securing mechanism 126. First flap strap securing mechanism 126 can be coupled to a second flap strap flap securing mechanism 130 located on inflatable carrier 100a. For example, inflatable carrier 100a can include flap securing straps 124a and 124b. Each flap securing strap 124a and 124b can include second flap strap flap securing mechanism 130. More specifically, flap strap 116a can be secured to flap securing strap 124a using first flap strap securing mechanism 126 on flap strap 116a and second flap strap securing mechanism 130 on flap securing strap 124a and flap strap 116b can be secured to flap securing strap 124b using first flap strap securing mechanism 126 on flap strap 116b and second flap strap securing mechanism 130 on flap securing strap 124b. First flap strap securing mechanism 126 and second flap strap securing mechanism 130 may be mating pairs of securing mechanisms such as snaps, buckles, cam buckles, side release buckles, slides, loops, snap hooks, D-rings, etc.

Turning to FIG. 1B, FIG. 1B is a simplified orthographic view of inflatable carrier 100a in accordance with one embodiment of the present disclosure. Due to the inflatable nature of inflatable carrier 100a, the profile of inflatable carrier 100a can conform to the profile of vehicle 108. In addition, inflatable carrier 100a can provide a relatively cushioned and forgiving experience when the transportable item is being transported by vehicle 108.

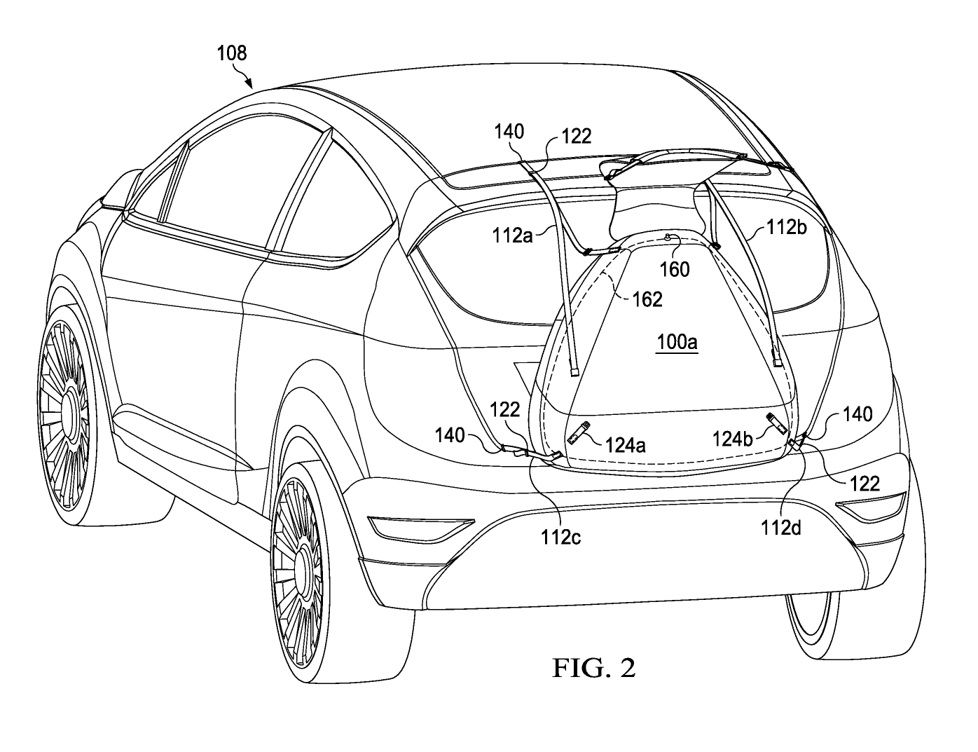

Turning to FIG. 2, FIG. 2 is a simplified orthographic view of inflatable carrier 100a in accordance with one embodiment of the present disclosure. Inflatable carrier 100a can include inflation means 160 and bladder 162. Inflation means 160 can be a valve or some other mechanism that allows air to be inserted into and removed from bladder 162 or otherwise inflate and deflate bladder 162. As illustrated, in FIG. 2, vehicle securing hooks 140 on inflatable carrier 100a have been attached to vehicle 108. Tightening mechanism 122 can be used to tighten vehicle securing straps 112a-112d and secure inflatable carrier 100a to vehicle 108 as illustrated in FIG. 1A.

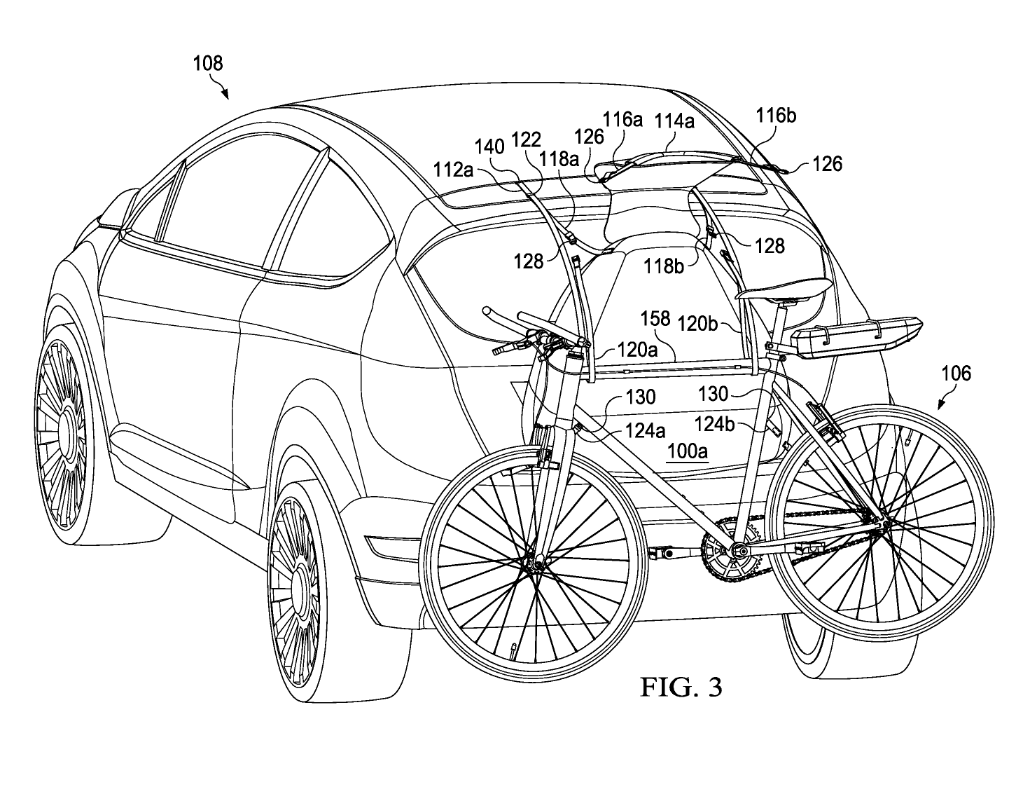

Turning to FIG. 3, FIG. 3 is a simplified orthographic view of inflatable carrier 100a in accordance with one embodiment of the present disclosure. As illustrated, in FIG. 3, inflatable carrier 100a has been secured to vehicle 108. Transportable item securing straps 120a and 120b can be wrapped or looped around a transportable item (e.g., a bicycle 106). Transportable item securing mechanisms 128 may be used to tighten transportable item securing straps 120a and 120b and secure the transportable item to inflatable carrier 100a. The transportable item may be a bicycle (as in FIG. 3), skis, wheelchair, camping chairs, beach equipment, lumber, supplies, or other transportable item that a user may want to secure to vehicle 108 using inflatable carrier 100a.

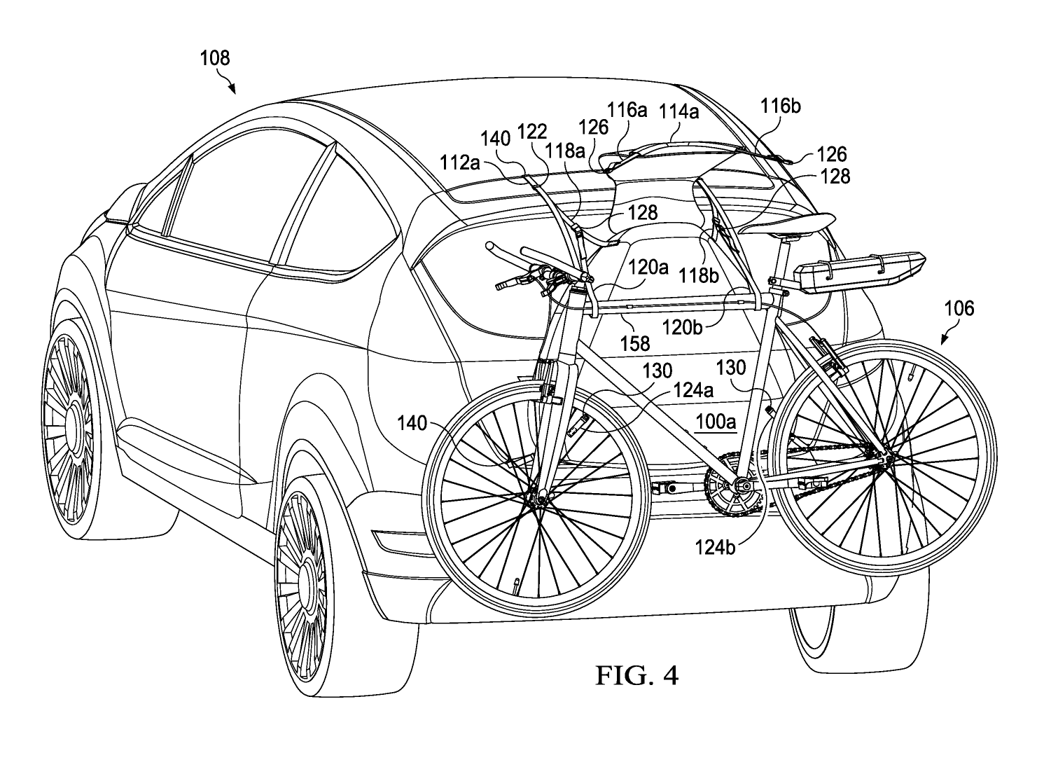

Turning to FIG. 4, FIG. 4 is a simplified orthographic view of inflatable carrier 100a in accordance with one embodiment of the present disclosure. As illustrated, in FIG. 4, bicycle 106 is being supported by inflatable carrier 100a. In this configuration, securing transportable item storage straps 120a and 120b have been wrapped around a horizontal top tube 158 of bicycle 106. Transportable item securing mechanisms 128 may be used to tighten transportable item securing straps 120a and 120b and secure bicycle 106 to inflatable carrier 100a.

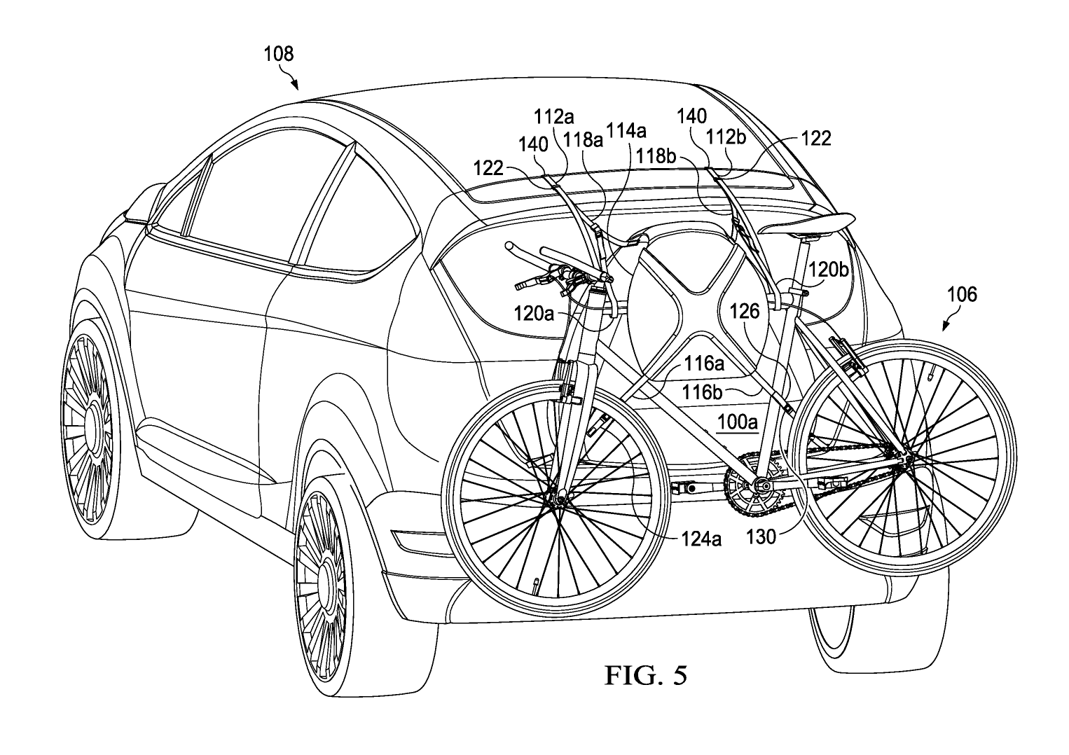

Turning to FIG. 5, FIG. 5 is a simplified orthographic view of inflatable carrier 100a in accordance with one embodiment of the present disclosure. As illustrated in FIG. 5, flap 114a has been pulled down over bicycle 106. Flap strap 116a has been secured to flap securing strap 124a (e.g., using first flap strap flap securing mechanism 126 on flap strap 116a and second flap strap flap securing mechanism 130 on flap securing strap 124a) and flap strap 116b has been secured to flap securing strap 124b (e.g., using first flap strap flap securing mechanism 126 on flap strap 116b and second flap strap flap securing mechanism 130 on flap securing strap 124b). In this configuration, bicycle 106 can be transported to a destination using a relatively cushioned carrier.

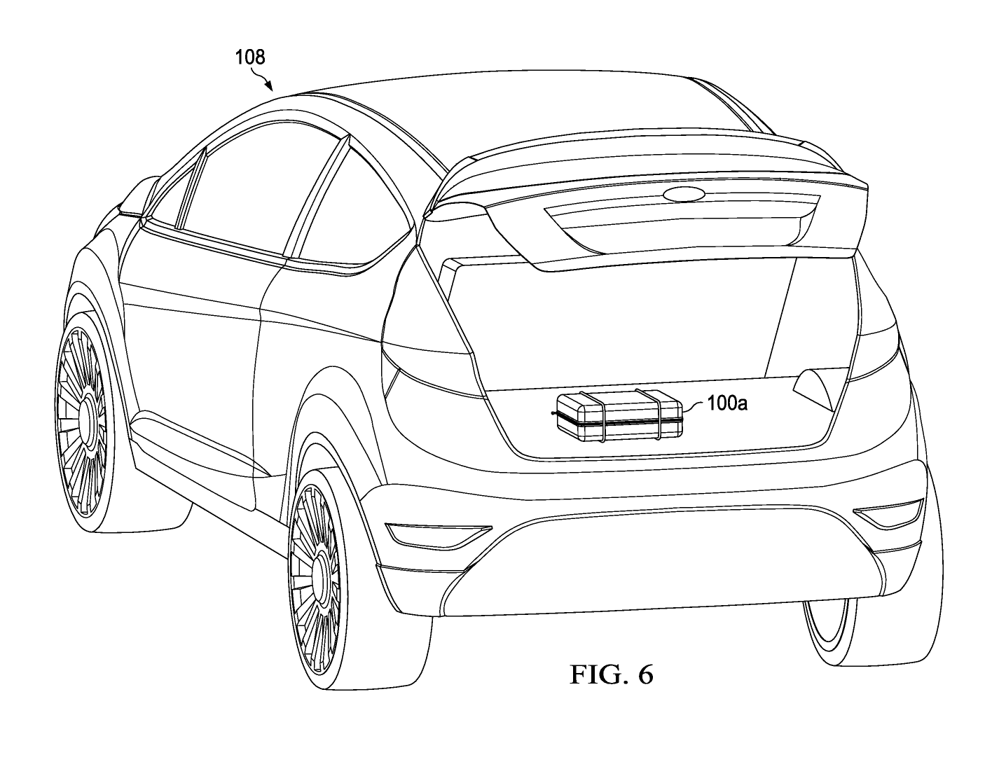

Turning to FIG. 6, FIG. 6 is a simplified orthographic view of inflatable carrier 100a in accordance with one embodiment of the present disclosure. As illustrated in FIG. 6, inflatable carrier 100a can be deflated and stored in the trunk or other area of vehicle 108. When deflated, inflatable carrier 100a can be portable and relatively easily carried or transported from one location to a different location or stored for later use. Inflatable carrier 100a may be deflated by opening inflation means 160 and release air from bladder 162. Inflatable carrier 100a may be reflated by opening inflation means 160 and forcing air into bladder 162.

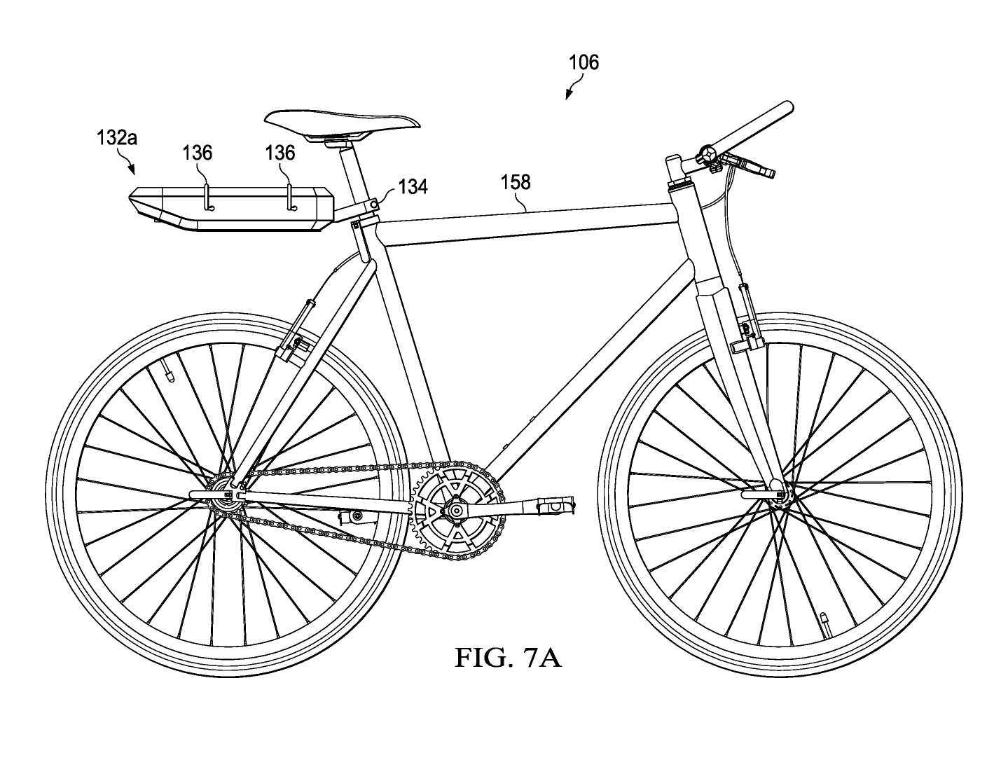

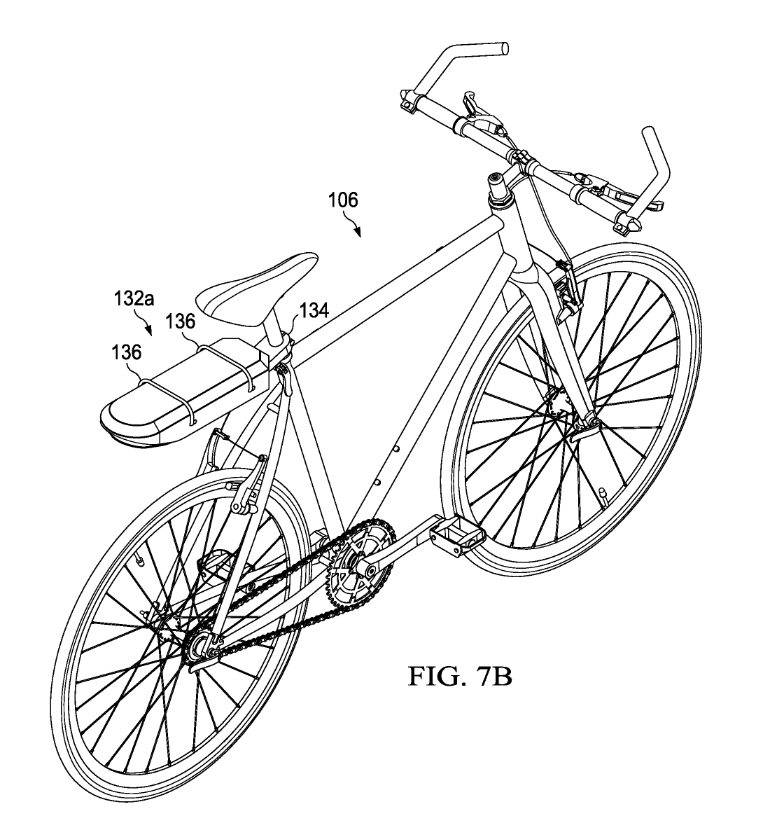

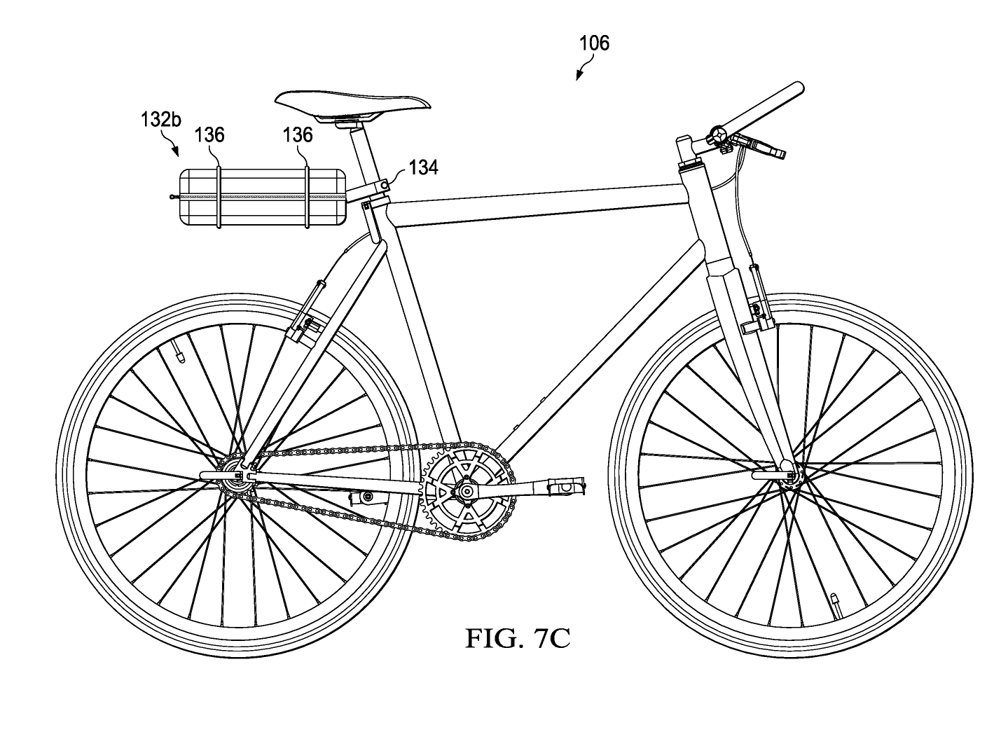

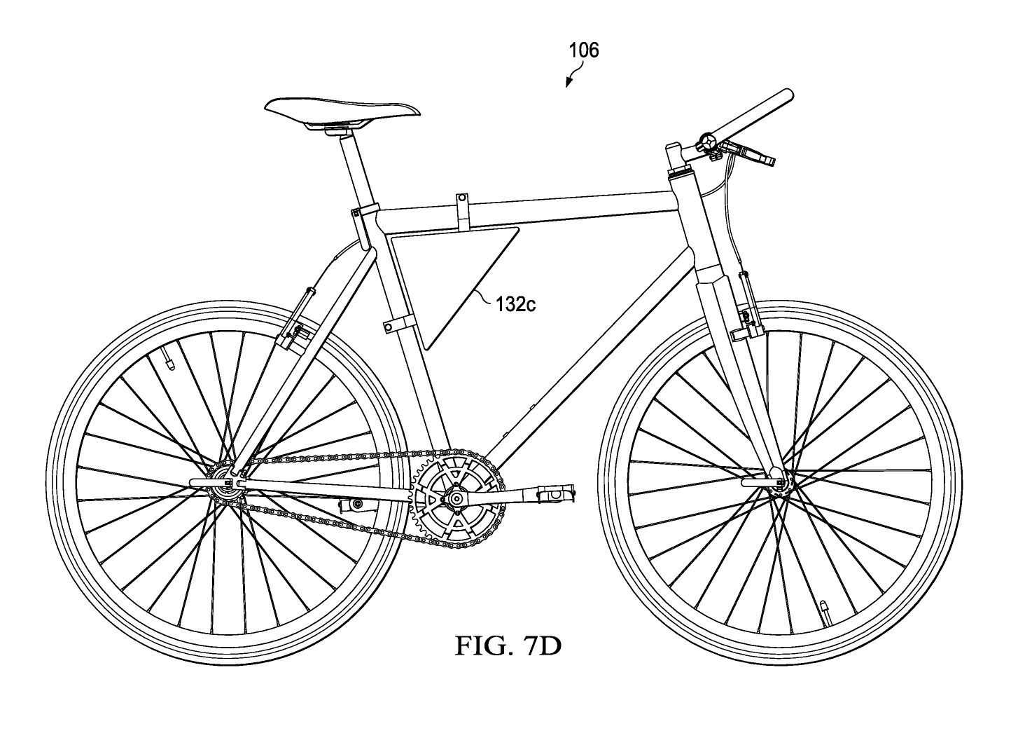

Turning to FIG. 7A, FIG. 7A is a simplified side view of an inflatable carrier housing 132a in accordance with one embodiment of the present disclosure. In an embodiment, inflatable carrier housing 132a may be located on bicycle 106. Inflatable carrier housing 132a can be configured to store or house a deflated inflatable carrier 100a similar to the one illustrated in FIG. 6. Inflatable carrier housing 132a can be attached to bicycle 106 using inflatable carrier housing attachment 134. Inflatable carrier housing 132a can include securing means 136 that can allow items such as boxes, bags, containers, books, etc. to be placed and secured onto inflatable carrier housing 132a. In one example, securing means 136 may be bungee cords or some other elastic securing means. Inflatable carrier housing attachment 134 can be removably attached to bicycle 106.

Turning to FIG. 7B, FIG. 7B is a simplified orthographic view of inflatable carrier housing 132a in accordance with one embodiment of the present disclosure. Turning to FIG. 7C, FIG. 7C is a simplified orthographic view of inflatable carrier housing 132b in accordance with another embodiment of the present disclosure. Turning to FIG. 7D, FIG. 7D is a simplified orthographic view of inflatable carrier housing 132c located on an inside portion of the frame of bicycle 106. As illustrated in FIGS. 7A-7D, the inflatable carrier housing (e.g., inflatable carrier housings 132a-132c) can have different profiles and may have any profile that will allow inflatable carrier housing 132 to store deflated inflatable carrier 100a on a transportable item (e.g., bicycle, skis, stroller, wheelchair, etc). In addition, the inflatable carrier may be located anywhere on bicycle 106 that does not interfere with the functionality of bicycle 106.

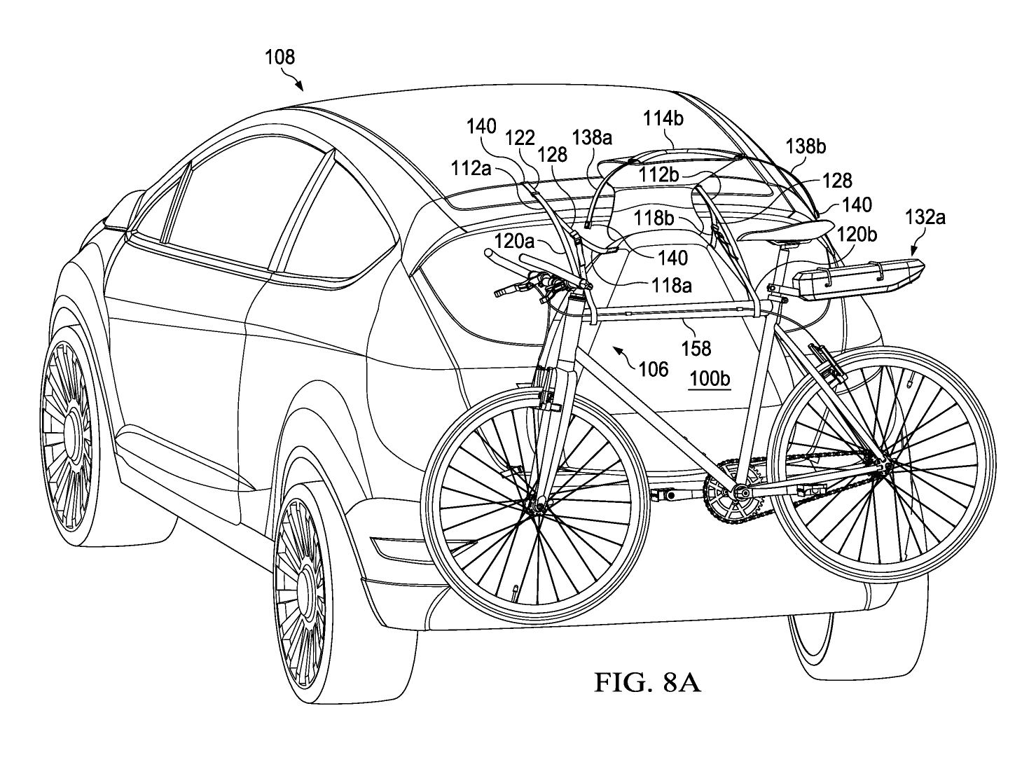

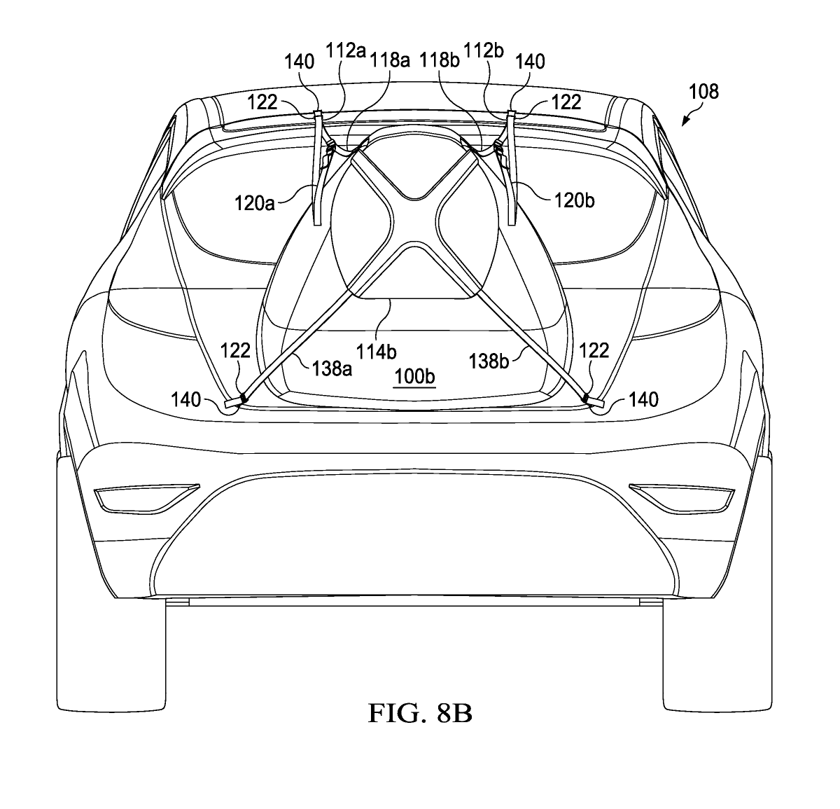

Turning to FIG. 8A, FIG. 8A is a simplified orthographic view of inflatable carrier 100b in accordance with one embodiment of the present disclosure. Inflatable carrier 100b can include vehicle securing straps 112a and 112b. In an example, after vehicle securing hooks 140 are attached to vehicle 108, tightening mechanism 122 can be used to tighten vehicle securing straps 112a and 112b and secure inflatable carrier 100b to vehicle 108. Vehicle securing straps 112a and 112b can each include inflatable carrier securing strap 118a and 118b and transportable item vehicle securing storage straps 120a and 120b.

Inflatable carrier 100b can also include transportable item flap 114b. Transportable item flap 114b can include vehicle flap securing straps 138a and 138b. Each vehicle flap securing strap 138a and 138b can be secured to flap 114b on one end and the other end can include vehicle securing hooks 140. When a transportable item (e.g., bicycle 106) is supported and secured by transportable item securing straps 120a and 120b, flap 114b can be positioned over the transportable item and vehicle securing hooks 140 on each vehicle flap securing strap 138a and 138b can be secured to vehicle 108. Thus helping secure inflatable carrier 100b to vehicle 108 and the transportable item to inflatable carrier 100b

Turning to FIG. 8B, FIG. 8B is a simplified orthographic view of inflatable carrier 100b in accordance with one embodiment of the present disclosure. For illustrating certain features of inflatable carrier 100b, the transportable item is not shown. As illustrated in FIG. 8B, flap 114b has been brought down over a front portion of inflatable carrier 100b and vehicle securing hooks 140 on each vehicle flap securing straps 138a and 138b have been secured to vehicle 108. A vehicle flap securing strap tightening mechanism (e.g., securing mechanism 122) can be used to tighten vehicle flap securing straps 138a and 138b to secure flap 114b on the transportable item and to secure inflatable carrier 100b to vehicle 108.

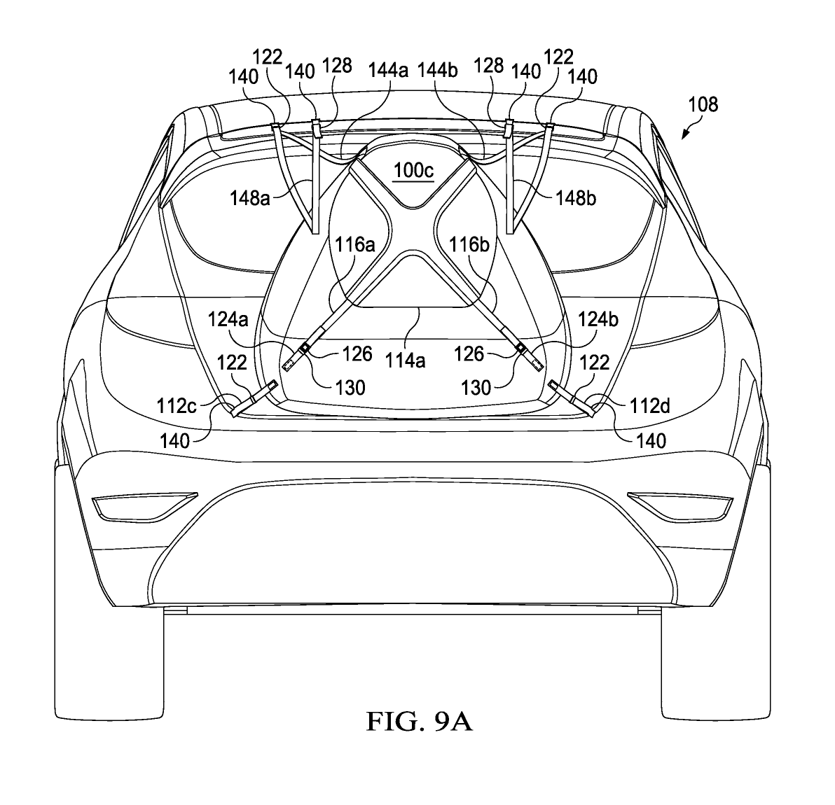

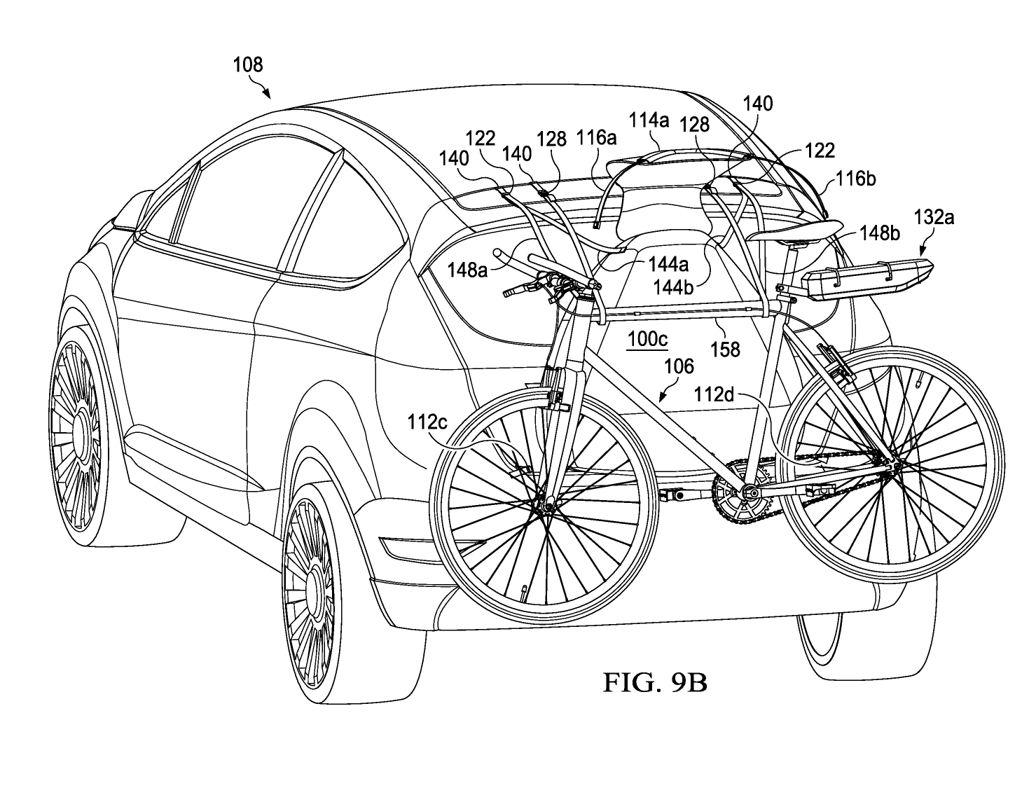

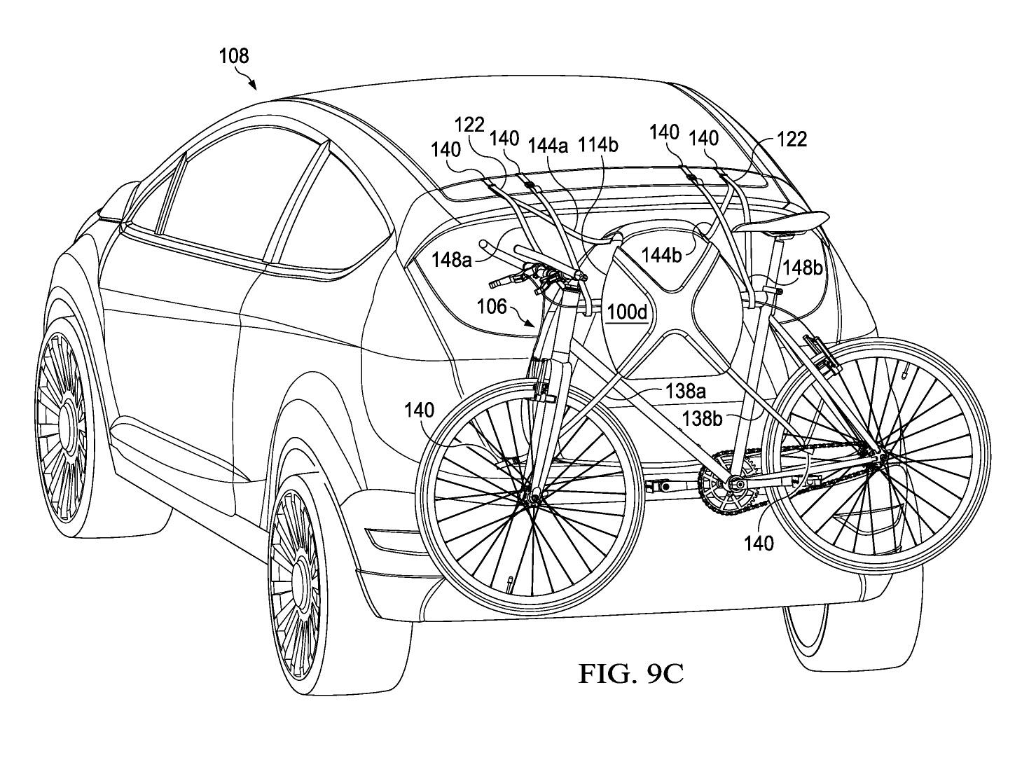

Turning to FIG. 9A, FIG. 9A is a simplified orthographic view of inflatable carrier 100c in accordance with one embodiment of the present disclosure. Inflatable carrier 100c can include vehicle securing straps 144a and 144b. One end of each vehicle securing strap 144a and 144b can be secured to inflatable carrier 100c while the other end of each vehicle securing strap 144a and 144b can include vehicle securing hook 140 and transportable item support straps 148a and 148b respectively. Each end of transportable item support straps 148a and 148b can include vehicle securing hook 140. In an example, after vehicle securing hooks 140 on vehicle securing strap 144a and 144b are attached to vehicle 108, tightening mechanism 122 can be used to tighten vehicle securing straps 144a and 144b and secure inflatable carrier 100b to vehicle 108. After inflatable carrier 100c is secured to vehicle 108, transportable item support straps 148a and 148b can be wrapped or looped around a transportable item. A transportable item securing mechanism 128 located on transportable item support straps 148a and 148b may be used to secure the transportable item to inflatable carrier 100c.

Turning to FIG. 9B, FIG. 9B is a simplified orthographic view of inflatable carrier 100c in accordance with one embodiment of the present disclosure. As illustrated, in FIG. 9B, bicycle 106 is being supported by transportable item support straps 148a and 148b. In this configuration, transportable item support strap 148a has been wrapped or looped around horizontal top tube 158 of bicycle 106 and secured to vehicle 108 using vehicle securing hooks 140. Transportable item support strap 148b has also been wrapped or looped around horizontal top tube 158 of bicycle 106 and secured to vehicle 108 using vehicle securing hooks 140. Transportable item securing mechanism 128 may be used to tighten transportable item support straps 148a and 148b and secure bicycle 106 to inflatable carrier 100c.

Turning to FIG. 9C, FIG. 9C is a simplified orthographic view of inflatable carrier 100d in accordance with one embodiment of the present disclosure. As illustrated, in FIG. 9C, bicycle 106 is secured to inflatable carrier 100d. Vehicle flap securing straps 138a and 138b on flap 114b have been secured to vehicle 108 and can overlap bicycle 106 and help secure bicycle 106 to inflatable carrier 100d.

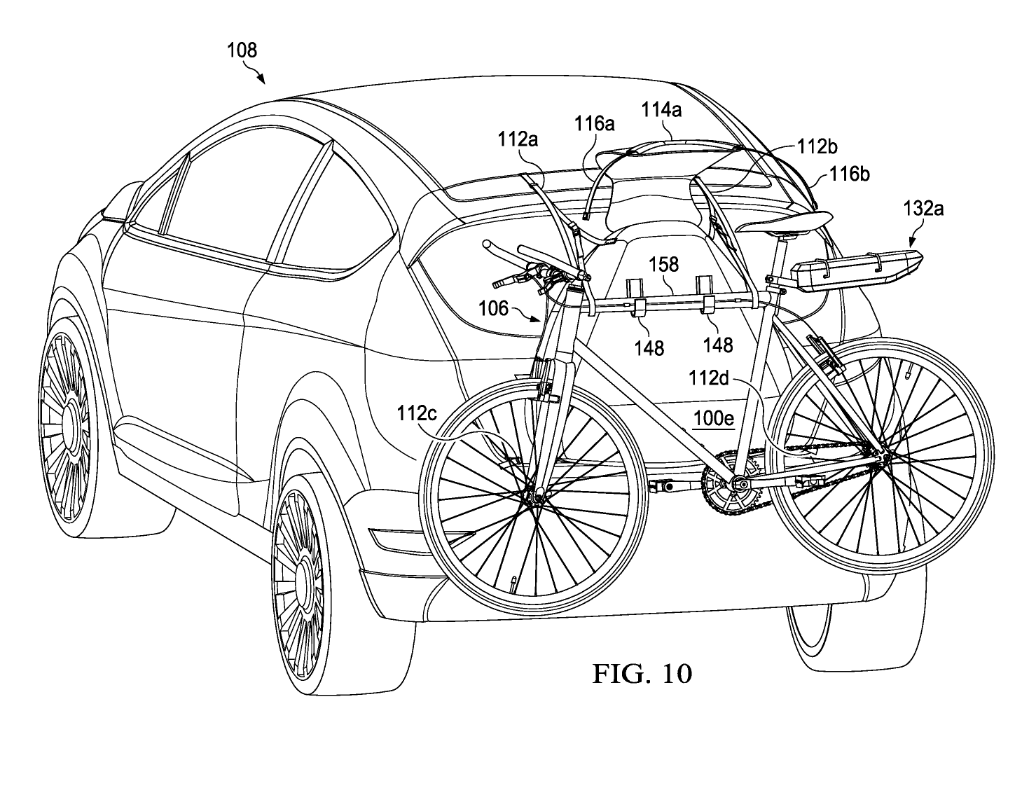

Turning to FIG. 10, FIG. 10 is a simplified orthographic view of inflatable carrier 100e in accordance with one embodiment of the present disclosure. As illustrated, in FIG. 10, inflatable carrier 100e can include one or more supports 150. One or more supports 150 can be configured to support horizontal top tube 158 of bicycle 106. Supports 150 may be used in addition to transportable item securing straps 120a and 120b, may be used alone, or may be used with some other configuration to support bicycle 106.

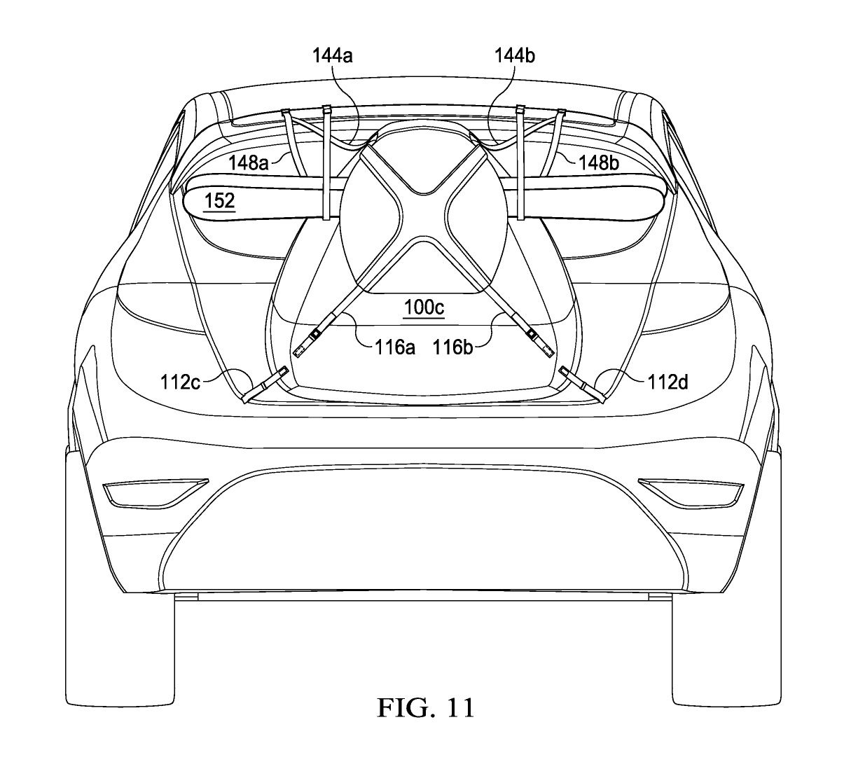

Turning to FIG. 11, FIG. 11 is a simplified plan view of inflatable carrier 100c in accordance with one embodiment of the present disclosure. As illustrated, in FIG. 11, inflatable carrier 100c can be configured to carry skis 152. It should be noted that inflatable carriers 100a, 100b, 100d, and 100e can similarly be configured to carry skis 152.

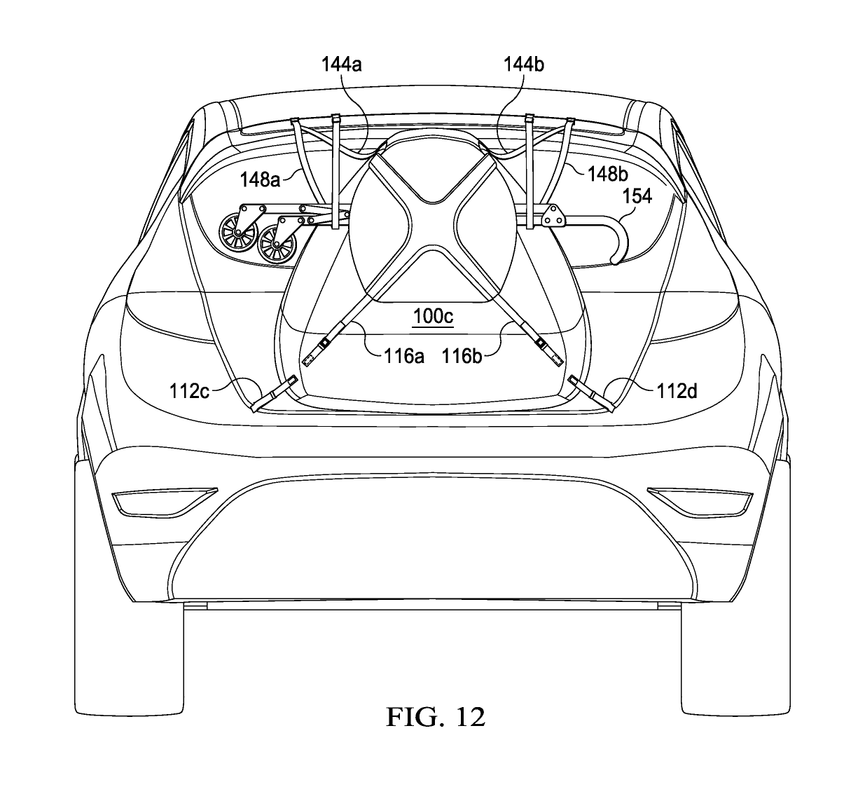

Turning to FIG. 12, FIG. 12 is a simplified plan view of inflatable carrier 100c in accordance with one embodiment of the present disclosure. As illustrated, in FIG. 12, inflatable carrier 100c can be configured to carry a stroller 154. As illustrated in FIGS. 1A-11, inflatable carriers 100a-100e can include many different configurations and can be configured to transport a variety of transportable items.

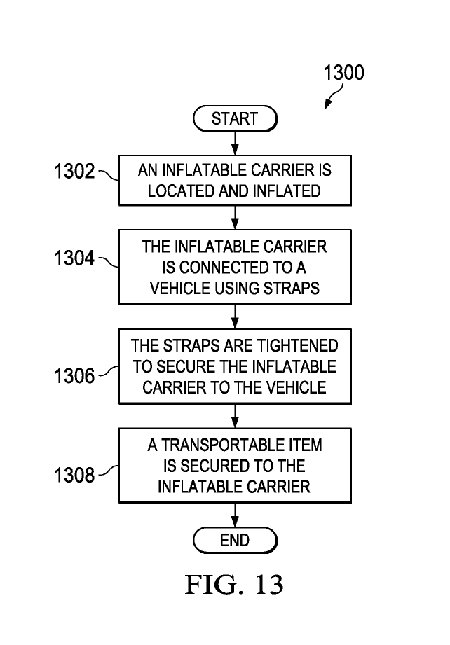

Turning to FIG. 13, FIG. 13 is an example flowchart illustrating possible operations of a flow 1300 that may be associated with an inflatable carrier for use on vehicles, in accordance with an embodiment. In an embodiment, one or more operations of flow 1300 may be performed by any of inflatable carriers 100a-100e. At 1302, an inflatable carrier is located and inflated. For example, inflatable carrier 100a may be stored on a bicycle, in a stroller, a trunk of a car, a backpack, etc. and bladder 162 may be inflated using inflation means 160. At 1304, the inflatable carrier is connected to a vehicle using straps. For example, as illustrated in FIG. 2, vehicle securing hooks 140 on inflatable carrier 100a can be attached to vehicle 108. At 1306, the straps are tightened to secure the inflatable carrier to the vehicle. For example, tightening mechanism 122 can be used to tighten vehicle securing straps 112a-112d and secure inflatable carrier 100a to vehicle 108 as illustrated in FIG. 1A. At 1308, a transportable item is secured to the inflatable carrier. For example, transportable item securing straps 120a and 120b can be wrapped or looped around a transportable item (e.g., a bicycle, skis, wheelchair, camping chairs, beach equipment, lumber, supplies, etc.). Transportable item securing mechanisms 128 may be used to tighten transportable item securing straps 120a and 120b and the transportable item to inflatable carrier 100a.

It is imperative to note that all of the specifications, dimensions, and relationships outlined herein (e.g., height, width, length, materials, etc.) have only been offered for purposes of example and teaching only. Each of these may be varied considerably without departing from the spirit of the present disclosure, or the scope of the appended claims. The specifications apply only to one non-limiting example and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example A1 is an air filled carrier including securing straps to secure the air filled carrier to a vehicle and transportable item securing straps to secure a transportable item to the air filled carrier.

In Example A2, the subject matter of Example Al may optionally include where the air filled carrier is inflatable and deflatable.

In Example A3, the subject matter of any of the preceding ‘A’ Examples can optionally include where the transportable item is a bicycle.

In Example A4, the subject matter of any of the preceding ‘A’ Examples can optionally include where the air filled carrier is stored on a bicycle.

In Example A5, the subject matter of any of the preceding ‘A’ Examples can optionally include where the air filled carrier is stored in the vehicle.

In Example A6, the subject matter of any of the preceding ‘A’ Examples can optionally include where a tightening mechanism can be used to tighten the securing straps and secure the air filled carrier to the vehicle.

In Example A7, the subject matter of any of the preceding ‘A’ Examples can optionally include where a transportable item securing mechanism can be used to tighten the transportable item securing straps to secure a transportable item to the air filled carrier.

Example M1 is a method that includes locating an inflatable carrier, attaching the inflatable carrier to a vehicle, and attaching a transportable item to the inflatable carrier.

In Example M2, the subject matter of any of the preceding ‘M’ Examples can optionally include inflating the inflatable carrier before it is attached to a vehicle.

In Example M3, the subject matter of any of the preceding ‘M’ Examples can optionally include where the transportable item is a bicycle.

In Example M4, the subject matter of any of the preceding ‘M’ Examples can optionally include where the inflatable carrier is stored on a bicycle.

In Example M5, the subject matter of any of the preceding ‘M’ Examples can optionally include where the inflatable carrier is stored in the vehicle.

In Example M6, the subject matter of any of the preceding ‘M’ Examples can optionally include activating a tightening mechanism to tighten securing straps and secure the inflatable carrier to the vehicle.

In Example M7, the subject matter of any of the preceding ‘M’ Examples can optionally include activating a transportable item securing mechanism to tighten transportable item securing straps and secure the transportable item to the air filled carrier.

Example AA1 can include a carrier for use on vehicles. The carrier can include a means for inflating the carrier, securing straps to secure the carrier to a vehicle, and transportable item securing straps to secure a transportable item to the carrier.

In Example AA2, the subject matter of any of the preceding ‘AA’ Examples can optionally include where the transportable item is a bicycle.

In Example AA3, the subject matter of any of the preceding ‘AA’ Examples can optionally include where the carrier is stored on a bicycle.

In Example AA4, the subject matter of any of the preceding ‘AA’ Examples can optionally include where the carrier is stored in the vehicle.

In Example AA5, the subject matter of any of the preceding ‘AA’ Examples can optionally include a tightening mechanism that can be used to tighten the securing straps and secure the carrier to the vehicle.

In Example AA6, the subject matter of any of the preceding ‘AA’ Examples can optionally include a transportable item securing mechanism that can be used to tighten the transportable item securing straps to secure the transportable item to the carrier.

What is claimed is:

1. An air filled carrier, comprising:
securing straps to secure the air filled carrier to a vehicle; and
transportable item securing straps to secure a transportable item to the air filled carrier.

2. The air filled carrier of claim 1, wherein the air filled carrier is inflatable and deflatable.

3. The air filled carrier of claim 1, wherein the transportable item is a bicycle.

4. The air filled carrier of claim 3, wherein the air filled carrier is stored on the bicycle.

5. The air filled carrier of claim 1, wherein the air filled carrier is stored in the vehicle.

6. The air filled carrier of claim 1, further comprising:
a tightening mechanism, wherein the tightening mechanism can be used to tighten the securing straps and secure the air filled carrier to the vehicle.

7. The air filled carrier of claim 1, further comprising:
a transportable item securing mechanism, wherein the transportable item securing mechanism can be used to tighten the transportable item securing straps and secure the transportable item to the air filled carrier.

8. A method comprising:
locating an inflatable carrier;
attaching the inflatable carrier to a vehicle; and
attaching a transportable item to the inflatable carrier.

9. The method of claim 8, further comprising:
inflating the inflatable carrier before it is attached to a vehicle.

10. The method of claim 8, wherein the transportable item is a bicycle.

11. The method of claim 10, wherein the inflatable carrier is stored on the bicycle.

12. The method of claim 8, wherein the inflatable carrier is stored in the vehicle.

13. The method of claim 8, further comprising:
activating a tightening mechanism to tighten securing straps and secure the inflatable carrier to the vehicle.

14. The method of claim 8, further comprising:
activating a transportable item securing mechanism to tighten transportable item securing straps and secure the transportable item to the inflatable carrier.

15. A carrier for use on vehicles, comprising:
inflation means for inflating and deflating the carrier;
securing straps to secure the carrier to a vehicle; and
transportable item securing straps to secure a transportable item to the carrier.

16. The carrier of claim 15, wherein the transportable item is a bicycle.

17. The carrier of claim 16, wherein the carrier is stored on the bicycle.

18. The carrier of claim 15, wherein the carrier is stored in the vehicle.

19. The carrier of claim 15, further comprising:
a tightening mechanism, wherein the tightening mechanism can be used to tighten the securing straps and secure the carrier to the vehicle.

20. The carrier of claim 15, further comprising:
a transportable item securing mechanism, wherein the transportable item securing mechanism can be used to tighten the transportable item securing straps to secure the transportable item to the carrier.
